(19) United States
(12) Patent Application Publication
(10) Pub. No.: US 2025/0332625 A1
(43) Pub. Date: Oct. 30, 2025

(54) COMPREHENSIVE TREATMENT METHOD FOR SALINIZED SOIL IN SEMI-ARID REGION

(71) Applicant: Institute of Land Engineering & Technology,Shaanxi Provincial Land Engineering Construction Group C, Xi'an (CN)

(72) Inventors: Jichang HAN, Xi'an (CN); Yingguo WANG, Xi'an (CN); Juan LI, Xi'an (CN); Haiou ZHANG, Xi'an (CN); Zhen GUO, Xi'an (CN); Chenxi YANG, Xi'an (CN); Jian WANG, Xi'an (CN); Tingting CAO, Xi'an (CN)

(73) Assignee: Institute of Land Engineering & Technology,Shaanxi Provincial Land Engineering Construction Group C, Xi'an (CN)

(21) Appl. No.: 19/260,652

(22) Filed: Jul. 7, 2025

Related U.S. Application Data
(63) Continuation of application No. PCT/CN2023/130083, filed on Nov. 7, 2023.

(30) Foreign Application Priority Data
May 8, 2023 (CN) 202310507258.X

(51) Int. Cl. B09C 1/08; A01B 79/02; A01C 21/00; A01G 25/06; B05B 1/20; C05F 11/02; C05G 1/00; C05G 3/80; C09K 17/44; E02B 13/00

(52) U.S. Cl. CPC B09C 1/08; A01B 79/02; A01C 21/005; A01G 25/06; B05B 1/20; C05F 11/02; C05G 1/00; C05G 3/80; C09K 17/44; E02B 13/00

(57) ABSTRACT

This application discloses a comprehensive treatment method for salinized soil in semi-arid region, comprises: stripping and collecting the topsoil; spreading sandy soil and/or loess soil as a imported soil layer; spreading an anti-seepage layer, a salt barrier layer and a membrane layer successively on the imported soil layer; mixing clay into the topsoil to obtain mixed soil; blending saline-alkali land conditioner with the mixed soil to obtain planted soil; spreading the planted soil on the membrane layer to obtain a planting layer. The method combines physical, hydraulic, chemical and biological remediation methods to comprehensively manage saline-alkali soil in semi-arid areas. It consumes less water resources, has a shorter treatment cycle, shows quick results, is conducive to plant growth, and can effectively inhibit the return of salt.

### CROSS-REFERENCE TO RELATED APPLICATION

This application is a continuation of International Application No. PCT/CN2023/130083, filed on Nov. 7, 2023, which claims priority to Chinese Patent Application No. 202310507258.X, titled “COMPREHENSIVE TREATMENT METHOD FOR SALINIZED SOIL IN SEMI-ARID REGION” and filed to the China National Intellectual Property Administration on May 8, 2023, the entire contents of which are incorporated herein by reference.

### TECHNICAL FIELD

This disclosure relates to the technical field of land engineering technology, specifically to the field of soil improvement technology, and specifically relates to a comprehensive treatment method for salinized soil in semi-arid region.

### BACKGROUND

The area of saline-alkali soil in China is large and widely distributed, which is one of the main constraints on the current agricultural development. Soil salinization refers to the process in which the salt in the bottom layer of the soil or groundwater rises to the surface with capillary water, and after the water evaporates, the salt accumulates in the surface soil. All types of soil that undergo salinization and alkalization processes are called saline-alkali soil, including saline soil, alkaline soil, and various salinized and alkalized soils. It usually occurs in areas with dry climate, high soil evaporation intensity, high groundwater level and a relatively large amount of soluble salts. It is the result of the combined influence of certain natural conditions such as climate, terrain and hydrogeology on the movement of water and salt.

The process and mechanism of the soil salinization and alkalization are rather complex. Its formation is a form of land degradation under the influence of natural factors and human activities. The fragile ecological geological environment in semi-arid areas is the objective basis for the formation of the soil salinization and alkalization.

The improvement of saline-alkali soil is a long-term systematic process. and is for creating a suitable soil environment for plant growth. Moreover, the degree of salinization and alkalization of saline-alkali soil varies greatly in different regions, and the improvement effects also differ significantly.

The existing methods for treating saline-alkali soil mainly consist of chemical and biological measures, mainly involving plants, microorganisms and the application of soil additives. These include: drainage and salt washing, adding chemical conditioners such as organic fertilizers, bacterial fertilizers, compound fertilizers, biochar and biological bacteria to saline-alkali soil, setting up interlayers to reduce salt return in saline-alkali soil, and using salt-tolerant plants to restore, etc. These methods have problems such as long treatment cycle, high treatment cost, inability to completely solve salinization. At present, most of the improvement methods for saline-alkali soil in semi-arid areas are single. Therefore, developing new and efficient comprehensive treatment methods for saline-alkali soil in semi-arid areas and conducting research on comprehensive improvement of saline-alkali soil are of great significance for promoting the complete realization of saline-alkali soil improvement.

Issued Patent CN103814647A provides a method suitable for the improvement of saline-alkali land in arid and semi-arid areas. The improvement is carried out through technical steps such as surface soil stripping, bottom layer rolling compaction, claypan pavement and filling, high density polyethylene (HDPE) film coveragi, organic mixed material pavement and filling, salt elimination blind pipe distribution, surface soil refilling, plant planting and the like, but no anti-seepage layer is set up, and the salt barrier layer (i.e., the organic material layer) is set too close to the planting layer, a certain extent affecting the absorption of nutrients by the growth of crops. Moreover, no saline-alkali land conditioner is used, and its ability to regulate the physical and chemical properties of the soil is also rather limited. Patent application CN106385836A provides a treatment method for secondary saline-alkali land in the Yellow River irrigation area, including: 1) constructing a concealed pipe salt drainage system, 2) land preparation, 3) setting up support pipes, 4) irrigation operations, 5) salt drainage and salt washing operations. Its treatment method is relatively simple, consumes a large amount of water resources, and the soil texture has not been improved. Issued Patent CN112085409A provides a underground water level regulation and control method for synergistically relieving soil desertification and secondary salinization of an arid area. It offers theoretical support for addressing desertification and secondary soil salinization caused by unreasonable groundwater level control. This method is highly theoretical, has a relatively limited application area, and fails to provide specific implementation measures.

### SUMMARY

To resolve the deficiencies of the existing technology, the present disclosure provides a method for improving saline-alkali soil in semi-arid areas by integrating physical, hydraulic, chemical and biological treatment methods.

To achieve the above-mentioned purpose, the technical solution adopted by the present disclosure is: a comprehensive treatment method for salinized soil in semi-arid region, including: stripping and collecting topsoil; spreading sandy soil and/or loess soil as an imported soil layer; arranging an anti-seepage layer, a salt barrier layer and a membrane layer successively on the imported soil layer; mixing clay into the topsoil to obtain mixed soil; blending saline-alkali land conditioner with the mixed soil to obtain planted soil; spreading the planted soil on the membrane layer to obtain a planting layer.

In some embodiments, a thickness of the imported soil layer is 2 cm to 6 cm.

In some embodiments, the raw materials of the anti-seepage layer are one or a combination of several of crushed stones, sand and permeable bricks, the raw material of the salt barrier layer is biochar, and the raw materials of the membrane layer are plastic film and/or non-woven fabric.

In some embodiments, a mass ratio of the clay in the mixed soil is 25wt % to 50wt %, and a soil cohesion of the mixed soil is 10 kPa to 20 kPa; the clay is silt in river ditch.

In some embodiments, the saline-alkali land conditioner is mixed with the mixed soil at a weight ratio of 1:2 to 1:6.

In some embodiments, a thickness of the anti-seepage layer is 150 mm to 300 mm, a thickness of the salt barrier layer is 50 mm to 100 mm, a thickness of the membrane layer is 50 mm to 100 mm.

In some embodiments, a thickness of the planting layer is determined by the type of crop being planted, it is 2 cm to 20 cm for herbs, 25 cm to 40 cm for shrubs, and 60 cm to 90 cm for trees.

In some embodiments, the saline-alkali land conditioner is consisted of the following components by weight parts: 20-25 parts of phosphogypsum, 8-10 parts of superphosphate, 8-10 parts of organic bentonite, 5-8 parts of calcium activator, 12-15 parts of humus, 6-8 parts of amino acids, 15-20 parts of organic compound fertilizer, and 0.5-1 part of ferrous sulfate.

In some embodiments, content of CaSO4·2H20 in the phosphogypsum is more than 95%, and the calcium activator is industrial sulfuric acid, content of H2SO4 is more than 92.5%.

In some embodiments, the content of CaSO4·2H2O in the phosphogypsum is 95.2%, and the calcium activator is industrial sulfuric acid, a content of H2SO4 is 93.0%.

In some embodiments, the organic compound fertilizer, by weight, is consisted of the following components: 20-25 parts organic fertilizer, 8-10 parts nitrogen fertilizer, 2-4 parts potassium fertilizer, and 6-10 parts phosphorus fertilizer.

In some embodiments, the method further includes a progress of information-based managing the soil, including: real-time monitoring of soil salt content index, meteorological environment and crop growth conditions, and timely processing salt discharge or corresponding spraying of pesticides and fertilizers based on the observed information.

In some embodiments, before stripping and collecting the topsoil, the method further includes: deep ploughing: breaking the plow layer of the soil and digging trenches inside the soil; spacing of the trenches being 10 cm to 30 cm, and the operation depth of the deep loosening machine being about 20 cm to 40 cm; and land leveling: leveling the land and back-filling the trenches by pushing each trench five times; the maximum slope of the land should being less than 15°, the time interval between the deep ploughing and the land leveling being 1 hour to 3 hours; where the time interval between the deep ploughing and the land leveling is 1 hour to 3 hours.

In some embodiments, after mixing the saline-alkali land conditioner, the method further includes a process of mixing organic fertilizer to obtain the planted soil.

In some embodiments, the method further includes setting sprinkler irrigation equipment; the sprinkler irrigation equipment includes at least one of micro-wet pipe or micro-spray pipe.

In some embodiments, the sprinkler irrigation equipment comprises micro-wet pipes; the micro-wet pipes are buried underground at a depth of 15 cm to 30 cm, and the pipes are arranged in parallel with a spacing of 30 cm to 50 cm.

In some embodiments, the sprinkler irrigation equipment comprises micro-spray pipes; the micro-spray pipes are installed on the ground surface, with parallel arrangement between the pipes at a spacing of 2 maters to 3 meters; multiple rotating nozzles are arranged on each micro-spray pipe, and the spacing between two adjacent rotating nozzles are 4 meters to 6 meters.

In some embodiments, the method further includes setting water storage ditches for collecting precipitation or irrigating water.

In some embodiments, spacing width between each two adjacent water storage ditches is 100 meters; the direction of the water storage ditches are perpendicular to the direction of groundwater flow, and the slope are set according to the slope of the field surface, with a slope of less than 1/400, the depth of each water storage ditch is 1.5 meters to 2.0 meters, the width of bottom of each water storage ditch is 2.0 meters to 4.0 meters, and opening width of each water storage ditch is 8.0 meters to 12.0 meters.

Compared with the existing technology, the beneficial effects or advantages of the present disclosure:
(1) A comprehensive treatment method for salinized soil in semi-arid region is provided. This method combines physical, hydraulic, chemical and biological remediation methods to comprehensively manage saline-alkali soil in semi-arid areas. It consumes less water resources, has a shorter treatment cycle and can effectively inhibit salt return.
(2) After improving the saline-alkali soil in the semi-arid area by applying the method provided by the present disclosure, the soil's water storage and moisture retention capacity is enhanced, the content of clay particles increases, the rate of water evaporation decreases, the speed of soil salinization slows down, and the soil texture and physical and chemical properties are improved.
(3) After improving the saline-alkali soil in the semi-arid area by applying the method provided by the present disclosure, the soil pH is regulated, water retention and salt resistance are enhanced, salt convection and dispersion occur between the water body and the soil, and the soil can discharge salt in a timely and effective manner.

### DETAILED DESCRIPTION

The technical solution of the present disclosure is described in combination with embodiments in below. However, the present disclosure is not limited to the embodiments as described below.

The experimental methods and detection methods in the following embodiments, unless otherwise specified, are all conventional methods. The said agents and materials, unless otherwise specified, can all be purchased on the market. The said index data, unless otherwise specified, are all measured by conventional methods.

In some embodiments, the present disclosure, a comprehensive treatment method for salinized soil in semi-arid region, includes the following steps:
1. Stripping and collecting topsoil on the surface of the land.
2. Spreading imported soil: spreading sandy soil and/or loess soil as an imported soil layer with a thickness of 2 cm to 6 cm on the land.
3. Salt isolating: spreading an anti-seepage layer, a salt barrier layer, and a membrane layer successively on the imported soil layer. The raw materials of the anti- seepage layer are one or a combination of crushed stones, sand, and permeable bricks, with a thickness of 150 mm to 300 mm. The salt barrier layer is a biochar layer with a thickness of 50 mm to 100 mm. The raw material of the biochar layer is the solid product of the decomposition of dead branches and fallen leaves of trees under high-temperature and oxygen-deficient conditions. The raw materials of the membrane layer are plastic film and/or non-woven fabric, with a thickness of 50 mm to 100 mm.
4. Mixing clay: mixing clay into the topsoil to obtain a mixed soil, where the addition ratio of the clay in the mixed soil is 25wt %- 50wt %. and the soil cohesion of the mixed soil reaches 10 kPa to 20 kPa. The clay can be the silt in a river gully.
5. Blending saline-alkali land conditioner: blending the saline-alkali land conditioner with the mixed soil to obtain planted soil. The saline-alkali land conditioner is evenly mixed with the mixed soil at a weight ratio of 1:2 to 1:6. The saline-alkali land conditioner can include the following components: phosphogypsum, superphosphate, organic bentonite, calcium activator, humus, amino acids, organic compound fertilizer, and ferrous sulfate. The saline-alkali land conditioner can also include other nutrients. In some preferred embodiments, the saline-alkali land conditioner by weight can be consist of the following components: 20-25 parts of phosphogypsum, 8-10 parts of superphosphate, 8-10 parts of organic bentonite, 5-8 parts of calcium activator, 12-15 parts of humus, 6-8 parts of amino acids, 15-20 parts of organic compound fertilizer, and 0.5-1 part of ferrous sulfate. The organic compound fertilizer can include the following components: organic fertilizer, nitrogen fertilizer, potassium fertilizer, and phosphorus fertilizer. The organic compound fertilizer can also include other fertilizers. In some preferred embodiments, the organic compound fertilizer, by weight, can be consist of the following components: 20-25 parts organic fertilizer, 8-10 parts nitrogen fertilizer, 2-4 parts potassium fertilizer, and 6-10 parts phosphorus fertilizer.

The content of CaSO₄·2H₂O in phosphogypsum can be more than 95%, and preferred be 95.2%.

The calcium activator can be industrial sulfuric acid, and the content of H₂SO₄ in the calcium activator can be more than 92.5%, and preferred be 93.0%.

The saline-alkali land conditioner can regulate the acidity and alkalinity of soil, and can enhance the water retention capacity and salt resistance of soil.
6. Restoring and leveling the planted soil on the membrane layer to obtain a planting layer, then planting the seeds. The thickness of the planting layer depends on the type of crop being planted. For herbs, it is 2 cm to 20 cm, for shrubs, it is 25 cm to 40 cm; and for trees, it is 60 cm to 90 cm. The seeds can be seeds of crops such as sugar beet, sunflower, cotton, sorghum, corn, oat, alfalfa, licorice, melilot, single-leaf morning glory, salt marsh cordgrass, locust tree, white ash, and elm tree. In some embodiments, the thickness of the planting layer of corn can be 2 cm to 6 cm.

In other embodiments, the comprehensive treatment method can further includes one or more than one of the following processes: deep ploughing, Land leveling, mixing organic fertilizer and planting corn, setting sprinkler irrigation equipment, digging water storage ditches, information-based managing, and etc. These above processes will be described in detail in the following preferred embodiment.

In an preferred embodiment, the present disclosure, a comprehensive treatment method for salinized soil in semi-arid region, includes the following steps:
1.Deep ploughing: breaking the plow layer of the soil and digging trenches inside the soil by a deep loosening machine. Spacing width of two adjacent trenches is 10 cm to 30 cm, and the operation depth of the deep loosening machine is about 20 cm to 40 cm. Deep ploughing can thicken the topsoil layer, enhance the water-holding and moisture-retaining capacity of soil, promote soil maturation, accelerate nutrient decomposition and accumulation, and provide a deep soil layer for crop growth.
2. Land leveling: leveling the land and back-filling the trenches by a motor grader. During this process, the motor grader pushes each trench five times. The maximum slope of the land should be less than 15°. The time interval between the deep ploughing and the land leveling is 1 hour to 3 hours.
3. Spreading imported soil: stripping and collecting topsoil on the surface of the land, spreading sandy soil and/or loess soil as an imported soil layer with a thickness of 2 cm to 6 cm on the land.
4. Salt isolating: spreading an anti-seepage layer, a salt barrier layer, and a membrane layer successively on the imported soil layer. The raw materials of the anti-seepage layer are one or a combination of crushed stones, sand, and permeable bricks, with a thickness of 150 mm to 300 mm. The salt barrier layer is a biochar layer with a thickness of 50 mm to 100 mm. The raw material of the biochar layer is the solid product of the decomposition of dead branches and fallen leaves of trees under high-temperature and oxygen-deficient conditions. The raw materials of the membrane layer are plastic film and/or non-woven fabric, with a thickness of 50 mm to 100 mm.
5. Mixing clay: mixing clay into the topsoil to obtain a mixed soil, where the addition ratio of the clay in the mixed soil is 25wt %- 50wt %. and the soil cohesion of the mixed soil reaches 10 kPa to 20 kPa. The clay can be the silt in a river gully.
6. Blending saline-alkali land conditioner: blending the saline-alkali land conditioner with the mixed soil to obtain improved soil. The saline-alkali land conditioner is evenly mixed with the mixed soil at a weight ratio of 1:2 to 1:6. The saline-alkali land conditioner can include the following components: phosphogypsum, superphosphate, organic bentonite, calcium activator, humus, amino acids, organic compound fertilizer, and ferrous sulfate. The saline-alkali land conditioner can also include other nutrients. In some preferred embodiments, the saline-alkali land conditioner by weight can be consist of the following components: 20-25 parts of phosphogypsum, 8-10 parts of superphosphate, 8-10 parts of organic bentonite, 5-8 parts of calcium activator, 12-15 parts of humus, 6-8 parts of amino acids, 15-20 parts of organic compound fertilizer, and 0.5-1 part of ferrous sulfate. The organic compound fertilizer can include the following components: organic fertilizer, nitrogen fertilizer, potassium fertilizer, and phosphorus fertilizer. The organic compound fertilizer can also include other fertilizers. In some preferred embodiments, the organic compound fertilizer, by weight, can be consist of the following components: 20-25 parts organic fertilizer, 8-10 parts nitrogen fertilizer, 2-4 parts potassium fertilizer, and 6-10 parts phosphorus fertilizer.
7. Mixing organic fertilizer and planting seeds: mixing organic fertilizer evenly with the improved soil to obtain planted soil, and then restoring and leveling the planted soil on the membrane layer to obtain a planting layer, then planting the seeds. The thickness of the planting layer depends on the type of crop being planted. For herbs, it is 2 cm to 20 cm, for shrubs, it is 25 cm to 40 cm; and for trees, it is 60 cm to 90 cm. The seeds can be seeds of crops such as sugar beet, sunflower, cotton, sorghum, corn, oat, alfalfa, licorice, melilot, single-leaf morning glory, salt marsh cordgrass, locust tree, white ash, and elm tree. In some embodiments, the thickness of the planting layer of corn can be 2 cm to 6 cm.
8. Setting sprinkler irrigation equipment: where the sprinkler irrigation equipment can be a plurality of micro-wet pipes and/or micro-spray pipes. The micro-spray pipes can be parallelly installed on the ground surface, and two adjacent micro-spray pipes are arranged with a spacing of 2 meters to 3 meters. Multiple rotating nozzles are arranged on each micro-spray pipe, and the spacing width between two adjacent rotating nozzles are 4 meters to 6 meters. The micro-wet pipes can be parallelly buried underground at a depth of 15 cm to 30 cm in parallel and two adjacent micro-wet pipes are arranged at a distance of 30 cm to 50 cm.
9. Digging water storage ditches: digging ditches for collecting precipitation and irrigating water by a spacing of 100 meters. The direction of the water storage ditches should be perpendicular to the direction of groundwater flow, and the slope should be set according to the slope of the field surface, with a slope of less than 1/400. The depth of each water storage ditch can be 1.5 meters to 2.0 meters, the width of bottom of each water storage ditch can be 2.0 meters to 4.0 meters, and opening width of each water storage ditch can be 8.0 meters to 12.0 meters.
10. Information-based managing: real-time monitoring soil salt content index and crop growth. When the soil salt content index exceeds 0.1%, salt drainage should be carried out promptly. When crops grow abnormally and diseases occur, pesticides and fertilizers should be sprayed in a timely manner.

The content of CaSO₄·2H₂O in phosphogypsum can be more than 95%, and preferred be 95.2%.

The calcium activator can be industrial sulfuric acid, and the content of H₂SO₄ in the calcium activator can be more than 92.5%, and preferred be 93.0%.

### Example 1

This embodiment provides a preparation of a saline-alkali land conditioner in a comprehensive treatment method for salinized soil in semi-arid region.

The saline-alkali land conditioner is obtained according to the following composition and mass ratios: 20 parts of phosphogypsum, 8 parts of superphosphate, 8 parts of organic bentonite, 5 parts of calcium activator, 12 parts of humus, 7 parts of amino acids, 15 parts of organic compound fertilizer, and 0.5 parts of ferrous sulfate. The organic compound fertilizer is obtained according to the following composition and mass ratios: 20 parts of organic fertilizer prepared from animal manure and plant straw, 8 parts of nitrogen fertilizer, 3 parts of potassium fertilizer and 6 parts of phosphorus fertilizer. The saline-alkali land conditioner should be stored for future use after preparation.

### Example 2

This embodiment provides a preparation of a saline-alkali land conditioner in a comprehensive management method for saline-alkali soil in semi-arid areas.

The saline-alkali land conditioner is obtained according to the following composition and mass ratios: 25 parts phosphogypsum, 10 parts superphosphate, 10 parts organic bentonite, 8 parts calcium activator, 15 parts humus, 8 parts amino acids, 20 parts organic compound fertilizer, and 1 part ferrous sulfate. The organic compound fertilizer is obtained according to the following composition and mass ratios: 20 parts of organic fertilizer prepared from animal manure and plant straw, 8 parts of nitrogen fertilizer, 3 parts of potassium fertilizer and 6 parts of phosphorus fertilizer. The saline-alkali land conditioner should be stored for future use after preparation.

### Example 3

This embodiment provides the preparation of a saline-alkali land conditioner in a comprehensive management method for saline-alkali soil in semi-arid areas.

The saline-alkali land conditioner is obtained according to the following composition and mass ratios: 22 parts phosphogypsum, 9 parts superphosphate, 9 parts organic bentonite, 7 parts calcium activator, 13 parts humus, 6 parts amino acids, 17 parts organic compound fertilizer, and 0.5 parts ferrous sulfate. The organic compound fertilizer is obtained according to the following composition and mass ratio: 20 parts of organic fertilizer prepared from animal manure and plant straw, 8 parts of nitrogen fertilizer, 3 parts of potassium fertilizer and 6 parts of phosphorus fertilizer. The saline-alkali land conditioner should be stored for future use after preparation.

### Example 4

This embodiment provides an experiment on treatment of saline-alkali land along the Yellow River in Dali County and the cultivation of corn, by using a comprehensive management method for saline-alkali soil in semi-arid areas.

The experimental period was from May to October in 2021. The experiment was conducted in the saline-alkali land along the Yellow River in Dali County, and the corn variety ‘Xianyu 335’ was planted.
1.Deep ploughing: breaking the plow layer of the soil and digging trenches inside the soil by a deep loosening machine. Spacing width of two adjacent trenches is 30 cm, and the operation depth of the deep loosening machine is about 30 cm.
2. Land leveling: leveling the land and back-filling the trenches by a motor grader. The motor grader pushes each trench five times. The maximum slope of the land is less than 15°.
3. Spreading imported soil: stripping and collecting topsoil on the surface of the land, spreading sandy soil as an imported soil layer with a thickness of 2 cm on the land.
4. Salt isolating: spreading an anti-seepage layer, a salt barrier layer, and a membrane layer successively on the imported soil layer. The raw materials of the anti-seepage layer are combination of crushed stones, and sand with a thickness of 150 mm. The salt barrier layer is a biochar layer with a thickness of 50 mm. The raw material of the biochar layer is the solid product of the decomposition of dead branches and fallen leaves of trees under high-temperature and oxygen-deficient conditions. The raw materials of the membrane layer are plastic film with a thickness of 50 mm.
5. Mixing: mixing clay into the topsoil to obtain a mixed soil, where the addition ratio of the clay in the mixed soil is 35wt %. The soil cohesion of the mixed soil reaches 12kPa.
6. Blending saline-alkali land conditioner: blending the saline-alkali land conditioner in example 1 with the mixed soil to obtain improved soil. The saline-alkali land conditioner is evenly mixed with the mixed soil at a weight ratio of 1:3.
7. Mixing organic fertilizer and planting corn: mixing organic fertilizer evenly with the improved soil to obtain planting soil, and then restoring and leveling the planting soil on the membrane layer to obtain a planting layer with a thickness of 3 cm, then planting the corn seeds in the planting layer.
8. Setting sprinkler irrigation equipment: where the sprinkler irrigation equipment is a plurality of micro-spray pipes installed on the ground surface, and two adjacent micro-spray pipes are set in parallel with a spacing of 2 meters. Multiple rotating nozzles are arranged on each micro-spray pipe, and spacing width between two adjacent rotating nozzles is 5 meters.
9. Digging water storage ditches: digging ditches for collecting precipitation and irrigating water by a spacing of 100 meters. The direction of the water storage ditches is perpendicular to the direction of groundwater flow, and the depth of each water storage ditch is 1.5 meters.
10. Information-based managing: real-time monitoring soil salt content index and crop growth. When the soil salt content index exceeds 0.1%, salt drainage is carried out promptly. When crops grow abnormally and diseases occur, pesticides and fertilizers are sprayed in a timely manner.

After the above treatment, the soil porosity is improved, the soil structure is loose, the soil environment is more suitable for plant growth, water resources are saved, and the later operation and maintenance costs are also reduced accordingly. The specific physical and chemical property changes of the soil and the changes in corn yield are shown in Table 1.

Table 1 shows the changes of physical and chemical properties in soil and changes of corn yield

| | May (before corn | October (after corn |
|---|---|---|
| | planting) | harvest) |
| soil pH | 9.15 | 7.88 |
| soil salt content | 1.85 | 0.75 |
| content of soil organic matter | 4.7 g/kg | 11.3 g/kg |
| content of alkali-hydrolyzed | increased by 218.33% | |
| nitrogen in the soil | | |
| content of available phosphorus | increased by 78.09% | |
| in the soil | | |

| | |
|---|---|
| output of corn | increased by 25% |

As can be seen from Table 1, after the treatment by the method provided by the present disclosure, the soil pH and the soil salt content were significantly reduced, while the contents of the organic matter, alkali-hydrolyzed nitrogen and available phosphorus and corn yield were significantly increased. This indicates that the method provided by the present disclosure can significantly improve the soil texture and physical and chemical properties of saline-alkali land, and can regulate soil pH, enhance soil water retention and salt resistance, and promote crop yield increase.

### Example 5

This embodiment provides an experiment on treatment of saline-alkali land in Fuping County by using a comprehensive management method for saline-alkali soil in semi-arid areas.
1.Deep ploughing: breaking the plow layer of the soil and digging trenches inside the soil by a deep loosening machine. The operation depth of the deep loosening machine is about 30 cm.
2. Land leveling: leveling the land and back-filling the trenches by a motor grader. The maximum slope of the land is less than 12°.
3. Filling with imported soil: stripping and collecting topsoil on the surface of the land, spreading sandy soil as a imported soil layer with a thickness of 3 cm on the land.
4.Arranging an anti-seepage layer, a salt barrier layer and a membrane layer successively on the imported soil layer.
5.Mixing clay into the topsoil to obtain mixed soil.
6.Blending saline-alkali land conditioner and organic fertilizer: blending the saline-alkali land conditioner in example 1 with the mixed soil; the saline-alkali land conditioner being evenly mixed with the mixed soil at a weight ratio of 1:5; then blending the organic fertilizer evenly to obtain planted soil.
7. Digging water storage ditches: digging ditches for collecting precipitation and irrigating water with a spacing of 120 meters. The direction of the water storage ditches is perpendicular to the direction of groundwater flow, and the depth of each water storage ditch is 2.0 meters. The width of bottom of each water storage ditch is 2.0 meters, and opening width of each water storage ditch is 8.0 meters.
8. Information-based managing: real-time monitoring soil salt content index and crop growth. When the soil salt content index exceeds 0.1%, drainage is carried out promptly in water storage ditches.

After the above treatments, within one year of the establishment of the water storage ditch, the soil pH decreased from 9.33 to 8.30, the salt content dropped from 0.77 to 0.20, the groundwater level decreased by 0.18 meters, the soil nutrient content significantly increased, the soil structure became loose, and the soil environment was significantly more suitable for plant growth. This indicates that the method provided by the present disclosure can significantly regulate the soil pH in semi-arid areas. Regulate soil salinity and groundwater level, and improve soil texture and physical and chemical properties.

### Comparative Example 1

This comparative embodiment provides an experiment on the cultivation of corn after improvement on the saline-alkali land along the Yellow River in Dali County.

The experiment period was from May to October in 2021. The experiment was conducted in the saline-alkali land along the Yellow River in Dali County, and the corn variety ‘Xianyu 335’ was planted. Except for the conditions and operations mentioned in the test, the test time, environment, crop management and other conditions of this embodiment are the same as those of Example 4.
1. Deep ploughing: breaking the plow layer of the soil and digging trenches inside the soil by a deep loosening machine. Spacing width of two adjacent trenches is 30 cm, and the operation depth of the deep loosening machine is approximately 30 cm.
2. Land leveling: leveling the land and back-filling the trenches by a motor grader. The motor grader pushes each trench five times. The maximum slope of the land is less than 10°.
3. Spreading imported soil: stripping and collecting topsoil on the surface of the land, spreading sandy soil as an imported soil layer with a thickness of 2 cm on the land.
4. Salt isolating: spreading an anti-seepage layer, a salt barrier layer, and a membrane layer successively on the imported soil layer. The raw materials of the membrane layer are plastic film with a thickness of 100 mm. The salt barrier layer is a biochar layer with a thickness of 50 mm. The raw material of the biochar layer is the solid product of the decomposition of dead branches and fallen leaves of trees under high-temperature and oxygen-deficient conditions.
5. Mixing: mixing clay into the topsoil to obtain a mixed soil, where the addition ratio of the clay in the mixed soil is 25wt %.
6. Blending organic fertilizer and planting corn: blending organic fertilizer evenly with the mixed soil to obtain planted soil, and then restoring and leveling the planting soil on the membrane layer to obtain a planting layer with a thickness of 3 cm, then planting the corn seeds in the planting layer.
7. Setting sprinkler irrigation equipment: where the sprinkler irrigation equipment is a plurality of micro-spray pipes installed on the ground surface, and two adjacent micro-spray pipes are set in parallel with a spacing of 2 meters. Multiple rotating nozzles are arranged on each micro-spray pipe, and the spacing width between two adjacent rotating nozzles are 5 meters.
8. Digging water storage ditches: digging ditches for collecting precipitation and irrigating water by a spacing of 100 meters. The direction of the water storage ditches is perpendicular to the direction of groundwater flow, and the depth of each water storage ditch is 1.5 meters.
9. Information-based managing: real-time monitoring soil salt content index and crop growth. When the soil salt content index exceeds 0.1%, salt drainage is carried out promptly. When crops grow abnormally and diseases occur, pesticides and fertilizers are sprayed in a timely manner.

After the above treatments, the changes in soil physical and chemical properties and corn yield are shown in Table 2.

Table 2 shows the changes of physical and chemical properties in soil and changes of corn yield

| | May (before corn | October (after corn |
|---|---|---|
| | planting) | harvest) |
| soil pH | 9.15 | 8.42 |
| soil salt content | 1.85 | 1.16 |
| content of soil organic matter | 4.7 g/kg | 7.1 g/kg |
| content of alkali-hydrolyzed | increased by 67.91% | |
| nitrogen in the soil | | |
| content of available phosphorus | increased by 42.75% | |
| in the soil | | |

| | |
|---|---|
| output of corn | increased by 9% |

It can be seen from Table 2 that after the treatment by the method provided in this comparative embodiment, the soil pH and the salt content decreased, and the soil organic matter content, alkali-hydrolyzed nitrogen content, available phosphorus content and corn yield all increased. However, the degree of change of each index was significantly lower than that of Example 4. The method provided in this comparison example is inferior to that in Example 4 in terms of improving the soil texture and physical and chemical properties of saline-alkali land in semi-arid areas, regulating soil pH, enhancing soil water retention and salt resistance, and promoting crop yield increase.

As mentioned above, the present disclosure can be well realized. The above embodiments merely describe the preferred embodiments of the present disclosure and do not limit the scope of the present disclosure. Under the premise of not departing from the design spirit of the present disclosure, all kinds of changes and improvements made by ordinary technicians in the art to the technical solution of the present disclosure should fall within the protection scope determined by the present disclosure.

What is claimed is:

1. A comprehensive treatment method for salinized soil in semi-arid region, comprising:
stripping and collecting topsoil;
spreading sandy soil and/or loess soil as an imported soil layer;
arranging an anti-seepage layer, a salt barrier layer and a membrane layer successively on the imported soil layer;
mixing clay into the topsoil to obtain mixed soil;
blending saline-alkali land conditioner with the mixed soil to obtain planted soil;
spreading the planted soil on the membrane layer to obtain a planting layer.

2. The comprehensive treatment method of claim 1, wherein a thickness of the imported soil layer is 2 cm to 6 cm.

3. The comprehensive treatment method of claim 1, wherein the raw materials of the anti-seepage layer are one or a combination of several of crushed stones, sand and permeable bricks, the raw material of the salt barrier layer is biochar, and the raw materials of the membrane layer are plastic film and/or non-woven fabric.

4. The comprehensive treatment method of claim 1, wherein a mass ratio of the clay in the mixed soil is 25wt % to 50wt %, and a soil cohesion of the mixed soil is 10 kPa to 20 kPa; the clay is silt in river ditch.

5. The comprehensive treatment method of claim 1, wherein the saline-alkali land conditioner is mixed with the mixed soil at a weight ratio of 1:2 to 1:6.

6. The comprehensive treatment method of claim 1, wherein a thickness of the anti-seepage layer is 150 mm to 300 mm, a thickness of the salt barrier layer is 50 mm to 100 mm, a thickness of the membrane layer is 50 mm to 100 mm.

7. The comprehensive treatment method of claim 1, wherein a thickness of the planting layer is determined by the type of crop being planted, it is 2 cm to 20 cm for herbs, 25 cm to 40 cm for shrubs, and 60 cm to 90 cm for trees.

8. The comprehensive treatment method of claim 1, wherein the saline-alkali land conditioner is consisted of the following components by weight parts: 20-25 parts of phosphogypsum, 8-10 parts of superphosphate, 8-10 parts of organic bentonite, 5-8 parts of calcium activator, 12-15 parts of humus, 6-8 parts of amino acids, 15-20 parts of organic compound fertilizer, and 0.5-1 part of ferrous sulfate.

9. The comprehensive treatment method of claim 8, wherein content of CaSO₄·2H₂O in the phosphogypsum is more than 95%, and the calcium activator is industrial sulfuric acid, content of H₂SO₄ is more than 92.5%.

10. The comprehensive treatment method of claim 9, wherein the content of CaSO₄·2H₂O in the phosphogypsum is 95.2%, and the calcium activator is industrial sulfuric acid, the content of H₂SO₄ is 93.0%.

11. The comprehensive treatment method of claim 8, wherein the organic compound fertilizer, by weight, is consisted of the following components: 20-25 parts organic fertilizer, 8-10 parts nitrogen fertilizer, 2-4 parts potassium fertilizer, and 6-10 parts phosphorus fertilizer.

12. The comprehensive treatment method of claim 1, further comprising a progress of information-based managing the soil, comprising:
real-time monitoring of soil salt content index, meteorological environment and crop growth conditions, and timely processing salt discharge or corresponding spraying of pesticides and fertilizers based on the observed information.

13. The comprehensive treatment method of claim 1, before stripping and collecting the topsoil, further comprising:
deep ploughing: breaking the plow layer of the soil and digging trenches inside the soil; spacing of the trenches being 10 cm to 30 cm, and the operation depth of the deep loosening machine being about 20 cm to 40 cm; and
land leveling: leveling the land and back-filling the trenches by pushing each trench five times; the maximum slope of the land should being less than 15°, the time interval between the deep ploughing and the land leveling being 1 hour to 3 hours;
wherein the time interval between the deep ploughing and the land leveling is 1 hour to 3 hours.

14. The comprehensive treatment method of claim 1, after mixing the saline-alkali land conditioner, further comprising a process of mixing organic fertilizer to obtain the planted soil.

15. The comprehensive treatment method of claim 1, further comprising setting sprinkler irrigation equipment; wherein the sprinkler irrigation equipment comprises at least one of micro-wet pipe or micro-spray pipe.

16. The comprehensive treatment method of claim 15, wherein the sprinkler irrigation equipment comprises micro-wet pipes; the micro-wet pipes are buried underground at a depth of 15 cm to 30 cm, and the pipes are arranged in parallel with a spacing of 30 cm to 50 cm.

17. The comprehensive treatment method of claim 15, wherein the sprinkler irrigation equipment comprises micro-spray pipes; the micro-spray pipes are installed on the ground surface, with parallel arrangement between the pipes at a spacing of 2 meters to 3 meters; multiple rotating nozzles are arranged on each micro-spray pipe, and the spacing between two adjacent rotating nozzles are 4 meters to 6 meters.

18. The comprehensive treatment method of claim 1, further comprising setting water storage ditches for collecting precipitation or irrigating water.

19. The comprehensive treatment method of claim 18, wherein spacing width between each two adjacent water storage ditches is 100 meters; the direction of the water storage ditches are perpendicular to the direction of groundwater flow, and the slope are set according to the slope of the field surface, with a slope of less than 1/400, the depth of each water storage ditch is 1.5 meters to 2.0 meters, the width of bottom of each water storage ditch is 2.0 meters to 4.0 meters, and opening width of each water storage ditch is 8.0 meters to 12.0 meters.
